(19) United States
(12) Patent Application Publication
(10) Pub. No.: US 2013/0192304 A1
(43) Pub. Date: Aug. 1, 2013

(54) Manufacturing Method for Glass Substrate for Information Recording Medium

(71) Applicants: Hazuki Nakae, Kyoto-shi (JP); Kazuyuki Nishi, Sakai-shi (JP); Toshiharu Mori, Settsu-shi (JP); Takeshi Endo, Osakasayama-shi (JP); Hiroaki Sawada, Sakai-shi (JP)

(72) Inventors: Hazuki Nakae, Kyoto-shi (JP); Kazuyuki Nishi, Sakai-shi (JP); Toshiharu Mori, Settsu-shi (JP); Takeshi Endo, Osakasayama-shi (JP); Hiroaki Sawada, Sakai-shi (JP)

(21) Appl. No.: 13/877,032

(22) PCT Filed: Aug. 23, 2011
(86) PCT No.: PCT/JP2011/004671

§ 371 Date: Mar. 29, 2013

(30) Foreign Application Priority Data
Sep. 30, 2010 (JP) 2010-221976

(51) Int. Cl. G11B 5/84

(52) U.S. Cl. CPC G11B 5/8404
USPC 65/30.1

(57) ABSTRACT

An aspect of the invention is directed to a method for manufacturing a glass substrate for an information recording medium including: a polishing step of polishing a surface of a raw glass plate, with use of a polishing solution containing a polishing agent and water; and a chemically reinforcing step of reinforcing the polished surface of the raw glass plate which has undergone the polishing step, with use of a chemically reinforcing treatment solution. The polishing step is a step of using, as the polishing agent, a polishing agent containing CeO₂, and of performing polishing in such a manner that the effective amount of CeO₂ per unit area of the surface of the raw glass plate to be used in the polishing is in the range of from 0.05 to 0.5 μg/cm².

### TECHNICAL FIELD

The present invention relates to a method for manufacturing a glass substrate for an information recording medium.

### BACKGROUND ART

There has been known an information recording device for recording information into an information recording medium, with use of magnetism, optics, and magneto-optics. An exemplified information recording device is a hard disk drive device. The hard disk drive device is a device for magnetically recording information into a magnetic disk as an information recording medium having a recording layer formed on a substrate, using a magnetic head. A glass substrate is suitably used as a base member for such an information recording medium, i.e., as a substrate.

Further, the hard disk drive device is configured to float the magnetic head from the magnetic disk without contacting the magnetic disk in recording information into the magnetic disk. There is known a technology of enhancing the recording density by reducing a floating amount of the magnetic head. In order to enhance the recording density by reducing a floating amount of the magnetic head, it is required to manufacture a glass substrate for an information recording medium having enhanced smoothness and enhanced cleanliness.

Such a glass substrate for an information recording medium is manufactured by polishing a raw glass plate multiple times. Specifically, patent literature 1 discloses a method for manufacturing a glass substrate for an information recording medium.

Patent literature 1 is directed to a method for manufacturing a glass substrate for an information recording medium including: a polishing step of polishing a surface of a glass substrate with use of abrasive grains containing cerium oxide; and a washing step of washing the glass substrate which has undergone the polishing step. In the above method for manufacturing a glass substrate for an information recording medium, after the washing step, the amount of cerium residues on the surface of the glass substrate is measured by an inductively coupled plasma mass spectrometer. In the case where the measured amount of cerium residues exceeds a predetermined value, the glass substrate is washed again after the washing step. According to the above method, it is possible to securely remove the polishing agent or foreign matter adhered to the glass substrate, without complicating the washing step.

Further, there has been an increasing opportunity of using the information recording device in the fields of requiring strength reliability such as notebook personal computers, car-mounted devices, and game devices. In view of the above, there is a demand for enhanced impact resistance, in addition to enhanced smoothness and enhanced cleanliness for the glass substrate for an information recording medium. As a method for enhancing the impact resistance of a glass substrate, there is known a chemically reinforcing method of immersing a glass substrate.

Specifically, a chemically reinforcing method is a method in which a glass substrate is heated in contact with a chemically reinforcing treatment solution such as a mixed melt of potassium nitrate and sodium nitrate. By performing the above method, the surface of the glass substrate is hardened. Conceivably, the above advantage is obtained as follows. Specifically, ions contained in the glass substrate are exchanged by ions contained in the chemically reinforcing treatment solution by contact with the chemically reinforcing treatment solution. In the contact, the ions in the glass substrate are exchanged by the ions having an ion radius larger than that of the ions in the glass substrate, and a reinforced layer capable of exerting a compressive stress is formed in the surface of the glass substrate which has undergone the ion exchange. Thus, it is conceived that the impact resistance of the glass substrate is enhanced.

### CITATION LIST

### Patent Literature

Patent literature 1: JP 2009-193608A

### SUMMARY OF INVENTION

An object of the invention is to provide a method for manufacturing a glass substrate for an information recording medium having enhanced smoothness and enhanced impact resistance.

An aspect of the invention is directed to a method for manufacturing a glass substrate for an information recording medium including a polishing step of polishing a surface of a raw glass plate with use of a polishing solution containing a polishing agent and water, and a chemically reinforcing step of reinforcing the surface of the raw glass plate which has undergone the polishing step, with use of a chemically reinforcing treatment solution. In the polishing step, a polishing agent containing CeO₂ is used as the polishing agent, and polishing is performed in such a manner that the effective amount of CeO₂ per unit area of the surface of the raw glass plate to be used in the polishing is in the range of from 0.05 to 0.5 μg/cm².

These and other objects, features and advantages of the present invention will become more apparent upon reading the following detailed description along with the accompanying drawings.

### BRIEF DESCRIPTION OF DRAWINGS

FIG. 1 is a top plan view showing a glass substrate for an information recording medium manufactured by a method for manufacturing a glass substrate for an information recording medium embodying the invention;

FIG. 2 is a schematic sectional view showing an example of a polishing machine for use in a rough polishing step or in a fine polishing step of the method for manufacturing a glass substrate for an information recording medium of the embodiment; and

FIG. 3 is a partially sectional perspective view showing a magnetic disk, as an example of a magnetic recording medium incorporated with a glass substrate for an information recording medium manufactured by the method for manufacturing a glass substrate for an information recording medium of the embodiment.

### DESCRIPTION OF EMBODIMENTS

As a result of study and experiment by the inventors of the present application, in some of the cases, the impact resistance of a glass substrate is not sufficiently enhanced, regardless of application of a chemically reinforcing method. One of the reasons is conceivably because the chemically reinforcing method is not sufficiently applied depending on a state of a glass substrate to which the chemically reinforcing method is applied after a polishing step is performed. Specifically, there is a case that ion exchange does not appropriately progress even if a chemically reinforcing treatment solution is heated in contact with the surface of a glass substrate, and an appropriate reinforced layer is not formed. In view of the above, in order to sufficiently enhance the impact resistance of a glass substrate by applying a chemically reinforcing method, it is necessary to enhance smoothness and cleanliness of the glass substrate to which the chemically reinforcing method is applied for appropriately progressing ion exchange in the surface of the glass substrate. Specifically, in the invention disclosed in patent literature 1, polishing is performed with use of, as a polishing solution, a slurry solution, in which the mixing ratio of water and a polishing agent is in the range of from about 1:9 to 3:7. However, further research and development on the polishing solution are necessary for sufficiently enhancing the impact resistance of a glass substrate. The invention disclosed in patent literature 1 has been made for the purpose of removing a polishing agent or foreign matter adhered to a glass substrate, and the polishing solution to be used in the polishing step is a generally available solution.

In view of the above, an object of the invention is to provide a method for manufacturing a glass substrate for an information recording medium having enhance smoothness and enhanced impact resistance.

In the following, an embodiment of the invention is described. The invention, however, is not limited to the embodiment.

A method for manufacturing a glass substrate for an information recording medium embodying the invention includes a polishing step of polishing a surface of a raw glass plate with use of a polishing solution containing a polishing agent and water, and a chemically reinforcing step of reinforcing the surface of the raw glass plate which has undergone the polishing step, with use of a chemically reinforcing treatment solution. In the polishing step, a polishing agent containing CeO₂ is used as the polishing agent, and polishing is performed in such a manner that the effective amount of CeO₂ per unit area of the surface of the raw glass plate to be used in the polishing is in the range of from 0.05 to 0.5 μg/cm².

Further, as far as the method for manufacturing a glass substrate for an information recording medium is provided with the polishing step and the chemically reinforcing step, the method for manufacturing a glass substrate for an information recording medium of the embodiment is not specifically limited. The method for manufacturing a glass substrate for an information recording medium of the embodiment is not specifically limited, and any conventional and well-known manufacturing method may be applied, except that the polishing step to be performed prior to the chemically reinforcing step has the aforementioned feature.

An exemplified method for manufacturing a glass substrate for an information recording medium includes a disk processing step, a lapping step (grinding step), a rough polishing step (primary polishing step), a washing step, a chemically reinforcing step, a fine polishing step (secondary polishing step), and a final washing step. These steps may be performed in the aforementioned order. Alternatively, the chemically reinforcing step and the fine polishing step (secondary polishing step) may be performed in the order opposite to the above-described order. Further, the method may further include a step or steps other than the above. For instance, an end surface polishing step may be provided between the lapping step and the rough polishing step (primary polishing step). In this embodiment, the polishing step to be performed prior to the chemically reinforcing step is a rough polishing step (primary polishing step). The end surface polishing step also corresponds to the polishing step to be performed prior to the chemically reinforcing step.

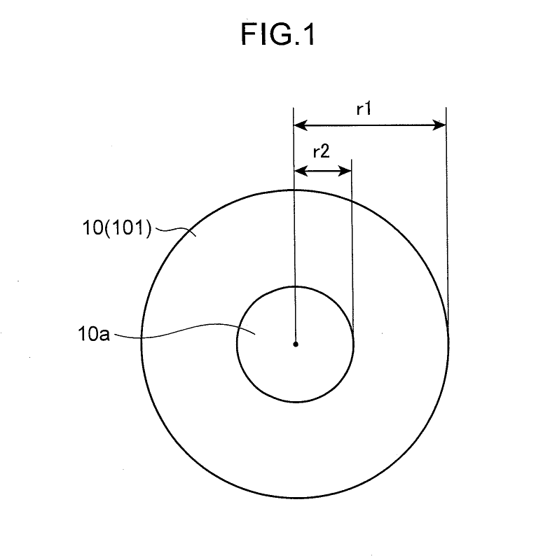

The disk processing step is a step of processing a raw glass plate, which is obtained by molding a glass material of a predetermined composition into a plate shape, into a disc-shaped raw glass plate 10 having a through-hole 10a formed in a center portion thereof in such a manner that an inner perimeter and an outer perimeter thereof are concentrically formed, as shown in FIG. 1. Specifically, the raw glass plate 10 is processed as follows. Firstly, a plate-shaped raw glass plate e.g. a plate-shaped raw glass plate manufactured by a below-mentioned floating method, having a glass composition as shown below and a thickness of 0.95 mm, is cut into a rectangular shape of a predetermined size. Then, circular cutting lines are formed on one surface of the raw glass plate by a glass cutter in such a manner that the aforementioned inner perimeter and outer perimeter are formed. Then, the raw glass plate having the cutting lines as described above is heated from the side of the surface where the cutting lines are formed. By application of the heat, the cutting lines are deepened toward the opposite surface of the raw glass plate. Thus, the raw glass plate is processed into the disc-shaped raw glass plate 10 having the through-hole 10a formed in the center portion thereof in such a manner that the inner perimeter and the outer perimeter thereof are concentrically formed. By the aforementioned disk processing step, it is possible to fabricate e.g. disc-shaped raw glass plates, wherein the outer diameter r1 is 2.5 inches (about 64 mm), 1.8 inch (about 46 mm), 1 inch (about 25 mm), 0.8 inch (about 20 mm), and the thickness is 2 mm, 1 mm, 0.63 mm. Further, in the case where the outer diameter r1 is set to 2.5 inches (about 64 mm), the raw glass plate has an inner diameter r2 of 0.8 inch (about 20 mm). FIG. 1 is a top plan view showing a glass substrate for an information recording medium to be manufactured by the method for manufacturing a glass substrate for an information recording medium of the embodiment.

Further, the method for manufacturing a plate-shaped raw glass plate is not specifically limited. For instance, a plate-shaped raw glass plate may be manufactured by a floating method. The floating method is a method, wherein a melt obtained by melting a glass material is allowed to flow onto molten tin, followed by solidification. The raw glass plate obtained by the floating method has such a characteristic that one surface thereof is a free surface made of glass and the other surface thereof is interface between glass and tin. Accordingly, the raw glass plate has a mirror surface with enhanced smoothness e.g. Ra of 0.001 μm or smaller. An example of the thickness of the raw glass plate is 0.95 mm. It is possible to measure the surface roughness e.g. Ra or Rmax of a raw glass plate or of a glass substrate, with use of a generally available surface roughness measuring device.

The lapping step is a step of processing the raw glass plate to have a predetermined plate thickness. An example of the lapping step is a step of grinding (lapping) both surfaces of a raw glass plate. By the lapping step, the parallelism, the flatness, and the thickness of the raw glass plate are adjusted. Further, the lapping step may be performed one time or more than one time. For instance, in the case where the lapping step is performed two times, the parallelism, the flatness, and the thickness of the raw glass plate are provisionally adjusted by the first-time lapping step (first lapping step), and the parallelism, the flatness, and the thickness of the raw glass plate are finely adjusted by the second-time lapping step (second lapping step). More specifically, an example of the first lapping step is a step of processing the overall surface of the raw glass plate to have a substantially uniform surface roughness.

More specifically, an example of the first lapping step is a step of processing the overall surface of the raw glass plate to have a substantially uniform surface roughness. For instance, it is possible to apply a mechanical method using isolated abrasive grains by a flat grinding machine. In measuring an arithmetic average roughness Ra of the raw glass plate at plural positions, it is preferable to set a difference between a minimum value and a maximum value of the obtained Ra in the range of from about 0.01 to 0.4 μm.

Further, in the second lapping step, it is preferable to set the arithmetic average roughness Ra of the raw glass plate to 0.1 μm or smaller, and it is more preferable to set the arithmetic average roughness Ra of the raw glass plate in the range of from 0.01 to 0.1 If the surface of the raw glass plate which has undergone the second lapping step is too rough, it tends to be difficult to obtain a glass substrate having sufficiently high smoothness, even if the rough polishing step and the fine polishing step to be described later are carried out. Further, the smoother the surface of the raw glass plate which has undergone the second lapping step is, namely, the smaller the Ra is, the better the surface quality of the raw glass plate is. In the lapping step, however, about 0.01 μm is a limit of the Ra. It is conceived that 0.01 μm is a lower limit of the arithmetic average roughness Ra of the raw glass plate which has undergone the second lapping step. As far as the arithmetic average roughness Ra of a raw glass plate which has undergone the second lapping step, i.e., of a raw glass plate which is subjected to the below-mentioned polishing step is 0.1 μm or smaller, it is possible to obtain a glass substrate for an information recording medium having enhanced smoothness and enhanced impact resistance. This is conceivably because the polishing step to be performed prior to the chemically reinforcing step is a step capable of enhancing smoothness and impact resistance, and it is possible to enhance the smoothness and the impact resistance of a finally obtained glass substrate by enhancing, to some extent the smoothness of a raw glass plate obtained by the grinding step to be performed prior to the polishing step. In other words, securing a certain degree of surface quality of a raw glass plate in the lapping step before the below-mentioned rough polishing step is advantageous in providing enhanced polishing performance in the rough polishing step.

As described above, the method for manufacturing a glass substrate for an information recording medium may preferably further include a step of grinding the raw glass plate prior to the polishing step, and the arithmetic average roughness Ra of the surface of the raw glass plate which has undergone the grinding step may preferably be 0.1 μm or smaller, and more preferably in the range of from 0.01 to 0.1 μm. In this configuration, it is possible to provide a method for manufacturing a glass substrate for an information recording medium having enhanced smoothness and enhanced impact resistance.

The above finding is based on the following observation.

Conceivably, it is possible to enhance the smoothness and the impact resistance of a finally obtained glass substrate by enhancing, to some extent, the smoothness of a raw glass plate which has undergone the grinding step to be performed prior to the polishing step, in addition to the polishing step to be performed prior to the chemically reinforcing step, wherein the polishing step is a step capable of enhancing the smoothness and the impact resistance as described above. Specifically, the arithmetic average roughness Ra of the surface of the raw glass plate which is subjected to the polishing step may preferably be 0.1 tun or smaller, and more preferably in the range of from 0.01 to 0.1 μm.

The rough polishing step (primary polishing step) is a step of subjecting the surface of the raw glass plate which has undergone the lapping step to rough polishing. The rough polishing is performed for the purpose of removing scratches or strain remaining after the aforementioned lapping step is carried out, and is performed by using a polishing machine to be described later. The surface to be polished in the rough polishing step is a surface in parallel to a plane direction of the raw glass plate i.e. a principal surface.

The washing step is a step of washing the raw glass plate which has undergone the rough polishing step.

The chemically reinforcing step is a step of immersing the raw glass plate in a chemically reinforcing solution for forming a chemically reinforced layer in the raw glass plate.

The fine polishing step is a mirror surface polishing treatment of finishing a principal surface into a smooth mirror surface having a surface roughness (Rmax) of about 6 nm or smaller, while maintaining the flat and smooth principal surface obtained by the rough polishing step. The fine polishing step is performed by the same polishing machine as used in the rough polishing step, except that a hard polishing pad is replaced by a soft polishing pad as a polishing pad. The surface to be polished in the fine polishing step is the principal surface that has been polished in the rough polishing step.

The final washing step is a step of washing so that the polishing agent is removed from the surface of the raw glass plate which has undergone the polishing step.

Further, in the case where the end surface polishing step is performed, the end surface polishing step is a step of polishing an inner circumferential end surface and an outer circumferential end surface of the raw glass plate. An example of the end surface polishing step is a step of polishing an inner circumferential end surface and an outer circumferential end surface of the raw glass plate into a mirror surface by a brush polishing method. The polishing agent to be used in the end surface polishing step is substantially the same as the polishing agent to be used in the rough polishing step. Further, in the end surface polishing step, it is preferable to polish the inner circumferential end surface and the outer circumferential end surface to have such a surface roughness that Rmax is set to about 0.4 μm or smaller, and Ra is set to about 0.1 μm or smaller. The inner circumferential end surface is a surface, on the inner peripheral side, perpendicular to the plane direction of the raw glass plate, and a surface, on the inner peripheral side, having an inclination with respect to the plane direction of the raw glass plate. Further, the outer circumferential end surface is a surface, on the outer peripheral side, perpendicular to the plane direction of the raw glass plate, and a surface, on the outer peripheral side, having an inclination with respect to the plane direction of the raw glass plate.

As described above, as far as the polishing step is performed prior to the chemically reinforcing step, the polishing step may be an end surface polishing step. Specifically, an example of the polishing step may be any one of a step of polishing a principal surface of the raw glass plate, a step of polishing an inner peripheral end surface of the raw glass plate, and a step of polishing an outer peripheral end surface of the raw glass plate.

Polishing with use of the polishing solution in one of the aforementioned steps is advantageous in enhancing the smoothness and the cleanliness of the raw glass plate which has undergone the polishing. Specifically, applying a chemically reinforcing step is advantageous in enhancing the impact resistance, as well as enhancing the smoothness. It is preferable to perform polishing with use of the polishing solution in all the steps.

In the method for manufacturing a glass substrate for an information recording medium of the embodiment, the aforementioned steps are carried out, whereby it is possible to manufacture a glass substrate for an information recording medium.

In the embodiment, the raw glass plate is not specifically limited. An example of the raw glass plate is a plate-shaped member made of a so-called aluminosilicate glass material. Aluminosilicate glass exhibits chemical reinforcement by performing a chemically reinforcing step, and with use of aluminosilicate glass, it is possible to manufacture a glass substrate having enhanced smoothness by performing a lapping step and by a polishing step.

Further, as an example of the raw glass plate, it is preferable to use a glass material having such a composition that SiO₂ is in the range of from 55 to 75 mass %, Al₂O₃ is in the range of from 5 to 18 mass %, Li₂O is in the range of from 1 to 10 mass %, Na₂O is in the range of from 3 to 15 mass %, K₂O is in the range of from 0.1 to 5 mass %, MgO is in the range of from 0.1 to 5 mass %, and CaO is in the range of from 0.1 to 5 mass %.

In the following, the rough polishing step is described.

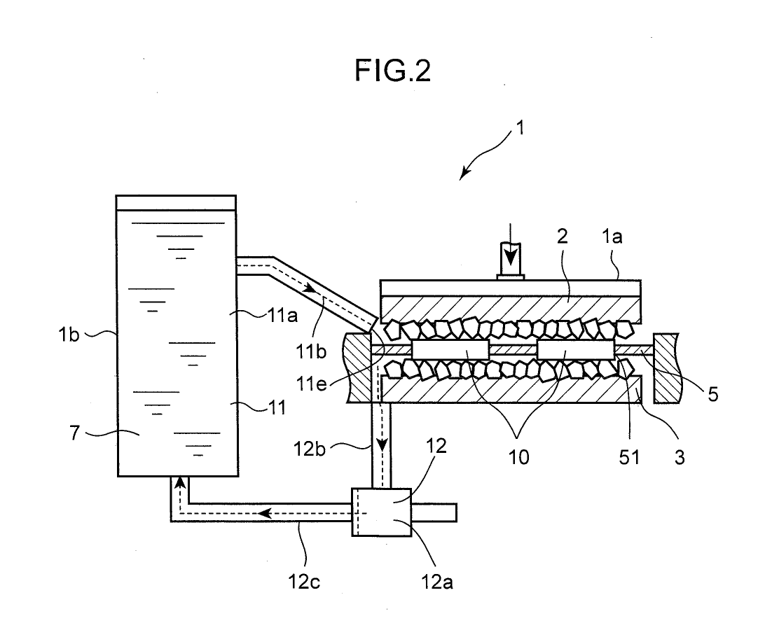

Firstly, as far as the polishing machine is usable in manufacturing a glass substrate, the polishing machine to be used in the rough polishing step is not specifically limited. An example of the polishing machine is a polishing machine 1 as shown in FIG. 2. FIG. 2 is a schematically sectional view showing an example of the polishing machine 1 to be used in the rough polishing step or in the fine polishing step of the method for manufacturing a glass substrate for an information recording medium of the embodiment.

The polishing machine 1 as shown in FIG. 2 is a machine capable of grinding both surfaces of a raw glass plate. Further, the polishing machine 1 is provided with a machine body 1a, and a polishing solution feeding portion 1b for feeding a polishing solution to the machine body 1a.

The machine body 1a is provided with a disc-shaped upper surface plate 2 and a disc-shaped lower surface plate 3. The upper surface plate 2 and the lower surface plate 3 are disposed vertically away from each other by a predetermined clearance so that the upper surface plate 2 and the lower surface plate 3 extend in parallel to each other. The disc-shaped upper surface plate 2 and the disc-shaped lower surface plate 3 are rotated in opposite directions to each other.

Polishing pads for polishing both surfaces i.e. a front surface and a back surface of the raw glass plate 10 are respectively attached to a surface of the disc-shaped upper surface plate 2 and to a surface of the disc-shaped lower surface plate 3 facing each other. As far as the polishing pad is usable in the rough polishing step, the polishing pad to be used in the rough polishing step is not specifically limited. An example of the polishing pad is a hard polishing pad made of polyurethane. Further, plural rotatable carriers 5 are disposed between the disc-shaped upper surface plate 2 and the disc-shaped lower surface plate 3.

As far as the polishing pad is usable in the rough polishing step, the polishing pad to be used in the rough polishing step is not specifically limited. Specifically, the hardness of the polishing pad is preferably a Shore A hardness in the range of from 65 to 95.

Each of the carriers 5 is formed with raw plate holding holes 51. A raw glass plate 10 is received and disposed in each of the raw plate holding holes 51. An exemplified carrier 5 may be configured to have one hundred raw plate holding holes 51, so that one hundred raw glass plates 10 are received and disposed in the one hundred raw plate holding holes 51, respectively. In the above configuration, it is possible to treat one hundred raw glass plates 10 by one treatment (one batch).

Each carrier 5 which is sandwiched between the upper and lower surface plates 2 and 3 via the polishing pads revolves in the same direction as the lower surface plate 3 about the center of rotation of the upper and lower surface plates 2 and 3 in a state that a certain number of raw glass plates 10 are held on the carrier 5. The disc-shaped upper surface plate 2 and the disc-shaped lower surface plate 3 may be operated by individual driving sources. In the polishing machine 1 thus operated, the raw glass plates 10 can be subjected to rough polishing by respectively feeding a polishing solution 7 (slurry solution) between the upper surface plate 2 and the raw glass plates 10, and between the lower surface plate 3 and the raw glass plates 10.

The polishing solution feeding portion 1b is provided with a solution storage portion 11 and a solution recovering portion 12. The solution storing portion 11 is provided with a solution storage body 11a, and a solution feeding tube 11b extending from the solution storage body 11a to the machine body la and having an ejection port 11e formed in the solution feeding tube 11b.

The solution recovering portion 12 is provided with a solution recovering body 12a, a solution recovering tube 12b extending from the solution recovering body 12a to the machine body 1a, and a solution feedback tube 12c extending from the solution recovering body 12a to the polishing solution feeding portion 1b.

The polishing solution 7 stored in the solution storage body 11a is fed from the ejection port 11e of the solution feeding tube 11b to the machine body 1a, and is recovered from the machine body 1a to the solution recovering body 12a through the solution recovering tube 12b.

Further, the recovered polishing solution 7 is fed back to the solution storage portion 11 through the solution feedback tube 12c, and is suppliable to the machine body 1a.

The polishing solution 7 to be used in the embodiment is a solution in a state that a polishing agent is dispersed in water, in other words, a slurry solution. An example of the polishing agent is a polishing agent containing CeO₂.

In the polishing step, polishing is performed in such a manner that the effective amount of CeO₂ per unit area of the surface of the raw glass plate to be used in the polishing is in the range of from 0.05 to 0.5 μg/cm².

As described above, it is possible to provide a method for manufacturing a glass substrate for an information recording medium having enhanced smoothness and enhanced impact resistance.

The above finding is based on the following observation.

Conceivably, in the polishing step to be performed prior to the chemically reinforcing step, it is possible to increase the polishing speed, and to enhance the smoothness of the raw glass plate which has undergone the polishing step by using a polishing agent containing CeO₂, as the polishing agent. The above finding is based on the following reason. Firstly, in the case where a raw glass plate is contacted with CeO₂ in a state that a pressure is applied to the surface of the raw glass plate in polishing, Si—O bond, which is a main composition in the surface of the raw glass plate, is replaced by Ce—O bond. Ce—O bond is easily broken, but bonding between Si and O is less likely to occur. In view of the above, it is conceived that use of a polishing agent containing CeO₂ is advantageous in increasing the polishing speed and in sufficiently enhancing the smoothness of the raw glass plate which has undergone the polishing step.

Further, in the polishing step to be performed prior to the chemically reinforcing step, a polishing agent containing CeO₂ is used as the polishing agent, and polishing is performed in such a manner that the effective amount of CeO₂ per unit area of the surface of the raw glass plate to be used in the polishing is in the range of from 0.05 to 0.5 μg/cm². The above configuration is advantageous in sufficiently enhancing the smoothness and the cleanliness of the raw glass plate which has undergone the polishing step, while maintaining the polishing speed. It is conceived that the above advantage is obtained by setting an effective pressure at the time of polishing to an appropriate pressure. Further, an excessive decrease of the effective amount of CeO₂ may make it difficult to maintain a high polishing speed, and may deteriorate the surface condition of the raw glass plate which has undergone the polishing step. Specifically, Ra tends to lower. Further, an excessive increase of the effective amount of CeO₂ tends to make it difficult to sufficiently suppress formation of scratches by polishing. This is conceivably because an effective pressure at the time of polishing is insufficient.

Further, it is conceived that uniform chemical reinforcement is secured by applying a chemically reinforcing step to the raw glass plate having such enhanced smoothness and cleanliness.

As described above, it is possible to manufacture a glass substrate for an information recording medium having enhanced smoothness and enhanced impact resistance.

Further, the glass substrate for an information recording medium having the thus enhanced smoothness contributes to reduction of a floating amount of a magnetic head with respect to an information recording medium obtained by forming a magnetic layer on a surface of the glass substrate. In other words, the glass substrate for an information recording medium having the thus enhanced smoothness contributes to an increase in the density of the recording bit of an information recording medium accompanied by an increase in the capacity of a hard disk drive device.

The aforementioned effective amount of CeO₂ indicates a mass of CeO₂ that actually contributes to polishing per unit area of a surface of a raw glass plate, as an object to be polished. It is possible to measure the effective amount of CeO₂ as follows. Firstly, a raw glass plate immediately after a polishing step is taken out. The raw glass plate is immersed in a mixing solution of 20 ml-nitric acid solution and 5 ml-aqueous solution of hydrogen peroxide for thirty minutes at a liquid temperature of 80° C. Thereafter, the amount of Ce in the mixing solution immersed with the raw glass plate is measured by an inductively coupled plasma mass spectrometer (ICP-MS). The mass of CeO₂ residing on the surface of the raw glass plate at the time of polishing is calculated based on the thus-measured mass of Ce. Then, an effective amount of CeO₂ is calculated based on the mass of CeO₂.

As far as it is possible to obtain the effective amount of CeO₂ in the range of from 0.05 to 0.5 μg/cm², the polishing solution is not specifically limited. For instance, preferably, the content of the polishing agent in the polishing solution may be in the range of 3 to 7 mass % with respect to water, the polishing solution may contain a dispersant having a negative electric charge, and the content of the dispersant may be in the range of from 0.25 to 5 parts by mass with respect to 100 parts by mass of CeO₂. Use of the polishing solution satisfying the above requirement is advantageous in enhancing the smoothness and the impact resistance of the finally obtained glass substrate.

The above finding is based on the following observation.

Conceivably, a dispersant having a negative electric charge is capable of suppressing agglomeration of the polishing agent, because the polishing agent dispersed in water and containing CeO₂ has a positive electric charge. Containing a dispersant having a negative electric charge in the polishing solution having a feature that the concentration of the polishing agent is lowered to such a level that the content of the polishing agent in the polishing solution is in the range of from 3 to 7 mass % with respect to water is advantageous in sufficiently enhancing the dispersibility of the polishing agent containing CeO₂. In other words, it is possible to prepare a polishing solution, in which the particle diameter distribution range of the polishing agent is narrow.

Conceivably, polishing with use of a polishing solution in which a polishing agent is appropriately dispersed as described above provides the following advantages. Namely, in view of a point that the particle diameter distribution range is narrow, it is less likely that the polishing agent may include polishing particles of an excessively small diameter or polishing particles of an excessively large diameter. Accordingly, it is possible to set an effective pressure at the time of polishing to an intended pressure. Thus, the above configuration is advantageous in enhancing the smoothness and the cleanliness of a raw glass plate which has undergone the polishing step, while maintaining the polishing speed. Further, it is conceived that the impact resistance can be enhanced by applying the chemically reinforcing step.

Specifically, it is preferable to set the content of the polishing agent in the polishing solution in the range of from 3 to 7 mass % with respect to water. An excessive decrease of the content of the polishing agent may make it difficult to maintain a high polishing speed, and may deteriorate the surface condition of the raw glass plate which has undergone the polishing step. Specifically, Ra tends to lower. This is conceivably because an excessive decrease of the content of the polishing agent may result in an excessive decrease of the effective amount of CeO₂. Further, an excessive increase of the content of the polishing agent tends to make it difficult to sufficiently suppress formation of scratches by polishing. This is conceivably because an excessive increase of the content of the polishing agent results in an excessive increase of the effective amount of CeO₂, which results in shortage of am effective pressure at the time of polishing.

As described above, it is possible to manufacture a glass substrate for an information recording medium having enhanced smoothness and enhanced impact resistance.

Further, preferably, the polishing solution may contain a dispersant having a negative electric charge. As far as it is possible to enhance the dispersibility of the polishing agent, the dispersant is not specifically limited. Examples of the dispersant include polycarboxylic acids, polyethyleneimines, polyvinyl sulfonic acids, and derivatives such as salts thereof. Further, among the aforementioned dispersants, polycarboxylic acids or derivatives of polycarboxylic acids may be preferable. Use of polycarboxylic acids or derivatives of polycarboxylic acids as a dispersant is advantageous in enhancing the smoothness and the impact resistance of a finally obtained glass substrate.

The above finding is based on the following observation.

Conceivably, use of polycarboxylic acids or derivatives thereof as the dispersant is advantageous in enhancing the dispersibility of the polishing agent by the dispersant. Specifically, it is conceived that polycarboxylic acids or derivatives thereof are dissolved in a polishing solution, and generate polymers having COO⁻ groups in the molecules thereof. It is conceived that the polymers are effective in enhancing the dispersibility of the polishing agent by the dispersant.

Further, as far as it is possible to enhance the dispersibility of the polishing agent, the molecular weight of the dispersant is not specifically limited. For instance, the number average molecular weight of the dispersant is preferably in the range of from about 500 to 2,500, and more preferably about 2,000. An excessively small molecular weight tends to make it difficult to sufficiently enhance the dispersibility of the polishing agent. This is conceivably because an excessively small molecular weight may make it difficult to encapsulate the polishing agent by the dispersant. Further, an excessively large molecular weight tends to make it difficult to sufficiently enhance the dispersibility of the polishing agent. This is conceivably because an excessively large molecular weight may easily cause agglomeration of the dispersant.

Further, as far as it is possible to enhance the dispersibility of the polishing agent, the pH of the dispersant is not specifically limited. For instance, preferably, the pH of a 1 mass % aqueous solution of the dispersant may be in the range of from 6.5 to 7.5. The polishing solution has a suitable pH. Accordingly, it is preferable to use the dispersant whose pH is near neutrality, and which is less influential on pH of the polishing solution. In other words, an excessively low pH or an excessively high pH tends to lower the polishing performance of the polishing solution. This is conceivably because an excessively low pH or an excessively high pH may excessively change the pH of the polishing solution by addition of the dispersant.

Further, as far as it is possible to enhance the dispersibility of the polishing agent, the viscosity of the dispersant is not specifically limited. For instance, preferably, the viscosity of the dispersant in a 1 mass % aqueous solution of the dispersant at 25° C. is 1.2 mPa·s or smaller. An excessively large viscosity tends to lower the polishing performance.

Further, it is preferable to set the content of CeO₂ with respect to the total mass of solid content of the polishing solution to 60 mass % or larger. In this configuration, it is possible to manufacture a glass substrate for an information recording medium having enhanced impact resistance, and it is possible to manufacture a glass substrate for an information recording medium having enhanced smoothness. Further, the above configuration is advantageous in increasing the polishing speed. It is conceived that these advantages are obtained because the content of CeO₂ capable of enhancing the polishing performance is sufficiently large with respect to the total mass of solid content of the polishing solution.

Further, the larger the content of CeO₂ with respect to the total mass of solid content of the polishing solution is, the better the polishing performance is. The content of CeO₂ is also affected by e.g. the degree of purity of CeO₂ in the polishing agent. This is conceivably because CeO₂ most greatly affects the polishing performance of a raw glass plate.

As far as the polishing solution contains, as a polishing agent to be contained, a polishing agent containing CeO₂, and polishing is performed in such a manner that the effective amount of CeO₂ per unit area of the surface of the raw glass plate to be used in the polishing is in the range of from 0.05 to 0.5 μg/cm², it is possible to use substantially the same materials as those of a generally available polishing agent to be used in manufacturing a glass substrate for an information recording medium.

Further, preferably, the polishing agent may have a maximum value in a particle size distribution measured by a laser diffraction/scattering method of 3.5 μm or smaller, and may have D50, which represents a particle diameter corresponding to 50 vol % in an accumulation curve, in the particle size distribution measured by the laser diffraction/scattering method in the range of from 0.5 to 1.5 μm.

An excessively small particle diameter of the polishing agent tends to lower the polishing speed. Further, an excessively large particle diameter of the polishing agent likely results in formation of scratches on a raw glass plate by polishing. In view of the above, it is conceived that use of a polishing agent satisfying the aforementioned particle diameter range, as the polishing agent, enables to suppress formation of scratches by polishing, while securing a high polishing speed. As described above, it is possible to manufacture a glass substrate for an information recording medium having enhanced impact resistance, and it is possible to manufacture an information recording medium having enhanced smoothness, while securing a high polishing speed.

The maximum value in the particle size distribution measured by the laser diffraction/scattering method means a particle diameter at a point corresponding to a maximum value of an accumulation curve, which is obtained by setting the total volume of a group of powders obtained by measurement with use of a laser diffraction particle size analyzer to 100%. Further, D50 means a particle diameter at a point corresponding to 50% in the accumulation curve, which is obtained by setting the total volume of a group of powders obtained by measurement with use of the laser diffraction particle size analyzer to 100%.

Further, preferably, in the rough polishing step, the content of fluorine in the polishing solution 7 is 5 mass % or smaller.

It is preferable to wash, in a washing step, the raw glass plate which has undergone the rough polishing in the rough polishing step. The washing step is not specifically limited. The following is an example of the washing step.

Firstly, a raw glass plate is washed with use of an alkaline solution at pH of 13 or higher for rinsing the raw glass plate. Then, the raw glass plate is washed with use of an acidic solution at pH of 1 or lower for rinsing the raw glass plate. Lastly, the raw glass plate is washed with use of an aqueous solution of hydrofluoric acid (HF) for washing the raw glass plate. Regarding cerium oxide, it is most efficient to wash in the order of alkaline washing, acidic washing, and HF washing. Specifically, the polishing agent is removed by dispersion with use of an alkaline solution, then, the polishing agent is removed by dissolution with use of an acidic solution, and lastly, the raw glass plate is etched by HF, whereby the polishing agent deeply rooted in the raw glass plate is removed.

In the washing step, it is preferable to perform alkali washing, acidic washing, and HF washing in individual tanks. This is because, in the case where these washings are performed in one tank, efficient washing may be difficult or impossible. In particular, in the case where an acidic solution and HF are put in one tank, it tends to be difficult to uniformly etch the substrate, because the etching speed of HF lowers at a portion where the amount of a polishing material is large. Further, it is preferable to use a rinsing tank after each of the washings is performed. A surface activating agent, a dispersant, a chelate agent, or a reducing agent may be added to these washing solutions, as necessary. Further, it is preferable to apply ultrasonic waves to each of the washing tanks, and to use deaerated water in each of the washing solutions.

Further, as another method, a raw glass plate is immersed in a washing solution containing 1 mass % of HF and 3 mass % of sulfuric acid. In the immersion, 80 kHz ultrasonic vibration is applied to the washing solution. Thereafter, the raw glass plate is taken out. Then, the raw glass plate is immersed in a neutral washing solution. In the immersion, 120 kHz ultrasonic vibration is applied to the neutral washing solution. Lastly, the raw glass plate is taken out, rinsed with deionized water, and is subjected to IPA drying.

Further, the raw glass plate which has undergone the rough polishing is washed in such a manner that the amount of cerium oxide on the surface of the raw glass plate is 0.125 ng/cm² or smaller. An excessively large amount of cerium oxide on the surface of the raw glass plate tends to make it difficult to secure an intended flatness of the raw glass plate which has undergone the fine polishing by the fine polishing step to be described later.

The chemically reinforcing step is a step of reinforcing the surface of the raw glass plate with use of a chemically reinforcing treatment solution. As far as a chemically reinforcing step usable in the method for manufacturing a glass substrate for an information recording medium is applied, the chemically reinforcing step is not specifically limited. An example of the chemically reinforcing step is a step of immersing a raw glass plate in a chemically reinforcing treatment solution. By the immersion, it is possible to form a chemically reinforced layer in the surface of the raw glass plate e.g. in a region away from the surface of the raw glass plate by 5 μm. Forming the chemically reinforced layer is advantageous in enhancing the impact resistance, the vibration resistance, and the heat resistance.

More specifically, the chemically reinforcing step is performed by an ion exchange method of exchanging alkali metal ions such as lithium ions or sodium ions that are contained in a raw glass plate for alkali metal ions such as potassium ions having a larger ion radius than that of the aforementioned alkali metal ions, by immersing the raw glass plate in a heated chemically reinforced treatment solution. A compressive stress is exerted on a region subjected to ion exchange due to strain resulting from a difference in ion radius, whereby the surface of the raw glass plate is reinforced.

In this embodiment, a chemically reinforcing step is applied to a raw glass plate which has undergone the polishing step, specifically, a step of using a polishing agent containing CeO₂ as the polishing agent and of performing polishing in such a manner that the effective amount of CeO₂ per unit area of the surface of the raw glass plate to be used in the polishing is in the range of from 0.05 to 0.5 μg/cm². Accordingly, a reinforced layer is appropriately formed by the chemically reinforcing step. Specifically, it is conceived that the chemical reinforcement is made uniform by the chemically reinforcing step, because the raw glass plate which has undergone the polishing step has enhanced smoothness. Thus, as described in the embodiment, it is possible to manufacture a glass substrate having enhanced impact resistance by applying a fine polishing step to an appropriately chemically reinforced raw glass plate.

As far as a chemically reinforcing treatment solution usable in a chemically reinforcing step in the method for manufacturing a glass substrate for an information recording medium is used, the chemically reinforcing treatment solution is not specifically limited. Examples of the chemically reinforcing treatment solution are a melt containing potassium ions, and a melt containing potassium ions and sodium ions. Examples of the melts are melts obtained by melting potassium nitrate, sodium nitrate, potassium carbonate, and sodium carbonate. Among these, it is preferable to use a melt obtained by melting potassium sulfate alone, or a melt obtained by combining a melt obtained by melting potassium nitrate and a melt obtained by melting sodium nitrate in the aspect of keeping the melting point low and in preventing deformation of a raw glass plate. It is more preferable to use a composite melt of a melt obtained by melting potassium nitrate and a melt obtained by melting sodium nitrate. In using the composite melt, it is preferable to use a composite solution, in which a melt obtained by melting potassium nitrate and a melt obtained by melting sodium nitrate are mixed substantially with the same amount as each other.

In the following, the fine polishing step is described.

The fine polishing step is a mirror surface polishing treatment of finishing the principal surface into a smooth mirror surface having a maximum height (Rmax) of the surface roughness of about 6 nm or smaller, while maintaining the flat and smooth principal surface obtained by the aforementioned rough polishing step. The fine polishing step is performed by replacing a hard polishing pad with a soft polishing pad as a polishing pad, while using the same polishing machine as used in the rough polishing step.

Further, as a polishing agent to be used in the fine polishing step, there is used a polishing agent capable of suppressing formation of scratches, although the polishing performance is lower than that of the polishing agent used in the rough polishing step. An example of the polishing agent is a polishing agent containing silica-based abrasive grains (colloidal silica) having a smaller particle diameter than that of the polishing agent used in the rough polishing step. Preferably, an average particle diameter of the silica-based abrasive grains is about 20 nm. In this embodiment, a polishing agent containing the colloidal silica is used.

Then, a polishing solution (slurry solution) containing the aforementioned polishing agent is fed to the raw glass plate, and the polishing pad is slidably moved relative to the raw glass plate for mirror polishing the surface of the raw glass plate. The slurry solution may be cyclically used by the polishing solution feeding portion 1b of the polishing machine 1.

The final washing step is a step of washing so that the polishing agent is removed from the surface of the raw glass plate which has undergone the polishing. For instance, the following step is applied to the raw glass plate which has undergone the fine polishing step.

Firstly, a raw glass plate which has undergone the fine polishing step is conveyed to a succeeding washing step in a wet state while keeping the raw glass plate in water, without drying (including natural drying) the raw glass plate. This is because drying the raw glass plate in a state that the polishing residues remain on the raw glass plate may make it difficult to remove the polishing agent (colloidal silica) by the washing step to be performed after the fine polishing step. In the final washing step, it is required to remove the polishing agent without impairing the mirror-finished surface of the raw glass plate.

As far as a washing solution usable in a final washing step in the method for manufacturing a glass substrate for an information recording medium is used, the washing solution to be used in the final washing step is not specifically limited. Specifically, it is preferable to use a washing solution which does not have an etching action or a leaching action, and which has such a composition that exhibits preferential solubility with respect to a polishing agent used in the fine polishing step e.g. with respect to a silica-based polishing agent. More specifically, it is preferable to select, as a washing solution, a composition free of hydrofluoric acid (HF) or hydrofluosilicic (H₂SiF₆), which may cause glass etching. Further, in the case where a washing solution has an etching action or a leaching action with respect to a raw glass plate, a mirror-finished surface of the raw glass plate may be impaired, and may result in a lacquer-finished surface. It is conceived that such a lacquer-finished surface may make it difficult or impossible to sufficiently suppress a floating amount of a magnetic head. In view of the above, it is preferable to use a washing solution which does not have an etching action or a leaching action, and which has such a composition that exhibits preferential solubility with respect to a polishing agent used in the fine polishing step. The raw glass plate is subjected to the final washing step as described above, whereby a glass substrate for an information recording medium is manufactured.

In the embodiment, a chemically reinforcing step is performed after a rough finishing step and before a fine polishing step. The order of the steps is not limited to the above, and may be changed, as necessary. For instance, a chemically reinforcing step may be performed after a fine finishing step. Further, in the case where the aforementioned end surface polishing step is performed, the end surface polishing step is a step of using a polishing agent containing CeO₂ as the polishing agent and of performing polishing in such a manner that the effective amount of CeO₂ per unit area of the surface of the raw glass plate to be used in the polishing is in the range of from 0.05 to 0.5 μg/cm² substantially in the same manner as in the rough polishing step.

The glass substrate for an information recording medium obtained as described above has enhanced smoothness and enhanced impact resistance.

The following is a description about a magnetic recording medium incorporated with a glass substrate for an information recording medium manufactured by the method for manufacturing a glass substrate for an information recording medium of the embodiment.

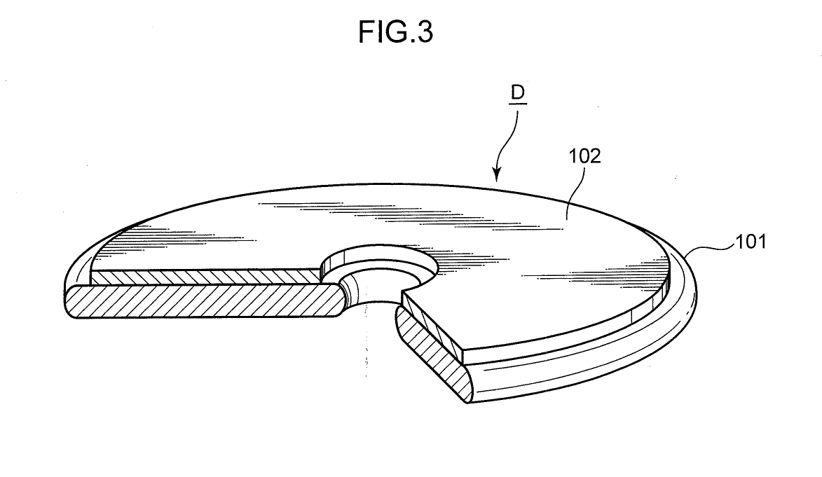

FIG. 3 is a partially sectional perspective view showing a magnetic disk, which is an example of a magnetic recording medium incorporated with a glass substrate for an information recording medium manufactured by the method for manufacturing a glass substrate for an information recording medium of the embodiment. The magnetic disk D is provided with a magnetic film 102 formed on a principal surface of a circular glass substrate 101 for an information recording medium. The magnetic film 102 is formed by a well-known and conventional forming method. Examples of the well-known and conventional method include a forming method (spin-coating method) of forming the magnetic film 102 on the glass substrate 101 for an information recording medium by spin-coating a heat curable resin containing dispersed magnetic particles, a forming method (sputtering method) of forming the magnetic film 102 on the glass substrate 101 for an information recording medium by sputtering, and a forming method (non-electrolytic plating method) of forming the magnetic film 102 on the glass substrate 101 for an information recording medium by non-electrolytic plating. The film thickness of the magnetic film 102 is in the range of about 0.3 to 1.2 μm in the case where a spin-coating method is performed, is in the range of about 0.04 to 0.08 μm in the case where a sputtering method is performed, and is in the range of about 0.05 to 0.1 μm in the case where a non-electrolytic plating method is performed. It is preferable to form a film by a sputtering method in the aspect of securing a recording medium having a reduced thickness and an increased recording density, and it is also preferable to form a film by a non-electrolytic plating method.

The magnetic material to be used for the magnetic film 102 is not specifically limited, and any well-known material may be used as the magnetic material to be used for the magnetic film 102. For instance, the magnetic material is based on Co having a high crystalline anisotropy in order to obtain a high retaining force, and preferably is a Co-based alloy, in which Ni or Cr is added for the purpose of adjusting a residual magnetic flux density. More specifically, examples of the magnetic material are compositions containing Co as a primary component such as CoPt, CoCr, CoNi, CoNiCr, CoCrTa, CoPtCr, CoNiPt, CoNiCrPt, CoNiCrTa, CoCrPtTa, CoCrPtB, and CoCrPtSiO. The magnetic film 102 may have a multilayer structure in which a non-magnetic film (e.g. Cr, CrMo, CrV) is interposed, such as CoPtCr/CrMo/CoPtCr, or CoCrPtTa/CrMo/CoCrPtTa for the purpose of reducing noise. The magnetic material to be used in the magnetic film 102 may be a ferrite-based material or an iron/rare earth-based material, in addition to the aforementioned magnetic materials. Further, it is possible to use a granular material having such a structure that magnetic particles such as Fe, Co, FeCo, CoNiPt are dispersed in a non-magnetic film made of e.g. SiO₂, BN. Further, it is possible to use a recording format of in-plane recording or vertical recording for recording onto the magnetic film 102.

Further, in order to enhance the smoothness of a magnetic head, a thin coat of a lubricant may be applied on the surface of the magnetic film 102. An example of the lubricant is obtained by diluting perfluoropolyether (PFPE) as a liquid lubricant with use of a Freon-based solvent.

Further, a foundation layer or a protective layer may be formed on the magnetic film 102, as necessary. The foundation layer in a magnetic disk D is optionally selected depending on the magnetic film 102. An exemplified material for the foundation layer is a material of at least one kind selected from the group of non-magnetic metals such as Cr, Mo, Ta, Ti, W, V, B, Al, and Ni. For instance, in the case where the magnetic film 102 contains Co as a primary component, the material for the foundation layer is preferably Cr or a Cr-based alloy in the aspect of enhancing the magnetic characteristics. Further, the foundation layer is not limited to a mono-layer, but may have a multilayer structure in which layers of one kind or layers of different kinds are laminated. Examples of the foundation layer having such a multilayer structure are multilayered foundation layers such as Cr/Cr, Cr/CrMo, Cr/CrV, NiAl/Cr, NiAl/CrMo, NiAl/CrV. Examples of a protective layer for preventing wear or corrosion of the magnetic film 102 include a Cr-layer, a Cr alloy layer, a carbon layer, a hydrogenated carbon layer, a zirconia layer, and a silica layer. It is possible to form the protective layer by an in-line sputtering device sequentially together with the foundation layer and the magnetic film 102. Further, the protective layer may be a mono-layer, or may have a multilayer structure in which layers of one kind or layers of different kinds are laminated. Another protective layer may be formed on the protective layer or in place of the protective layer. For instance, it is possible to form an SiO₂ layer on a Cr layer, in place of the protective layer. Such an SiO₂ layer is formed by dispersing colloidal silica particles in a diluent obtained by diluting tetraalkoxysilane with use of an alcohol-based solvent, coating the dispersant on the Cr layer, and firing the Cr layer.

The magnetic recording medium incorporated with the glass substrate 101 for an information recording medium of the embodiment as a substrate has a feature that the glass substrate 101 for an information recording medium has the aforementioned composition. Accordingly, it is possible to record/reproduce information for a long period with a high reliability.

In the foregoing, there has been described a case, in which the glass substrate 101 for an information recording medium of the embodiment is incorporated in a magnetic recording medium. The invention is not limited to the above. It is possible to incorporate the glass substrate 101 for an information recording medium of the embodiment in a magneto-optical disc or in an optical disc.

### EXAMPLES

In the following, examples of the invention are described, but the invention is not limited to these examples.

Firstly, polishing solutions as shown in Table 1 were prepared. The composition of each of the polishing solutions is substantially the same as that of a generally available polishing solution to be used in manufacturing a glass substrate for an information recording medium, except that the effective amounts of CeO₂ are as shown in Table 1, and that the contents of CeO₂ and the contents of dispersants with respect to the polishing solutions are as shown in Table 1.

The effective amounts of CeO₂ are the values obtained by the following measurement. Firstly, raw glass plates immediately after polishing were taken out, and the raw glass plates were immersed in a mixing solution of 20 ml-nitric acid solution and 5 ml-aqueous solution of hydrogen peroxide for thirty minutes at a liquid temperature of 80° C. Thereafter, the amounts of Ce in the mixing solution immersed with the raw glass plates were measured by an inductively coupled plasma mass spectrometer (ICP-MS). In the experiment, 7700s produced by Agilent Technologies was used as the inductively coupled plasma mass spectrometer. The masses of CeO₂ on the surfaces of the raw glass plates at the time of polishing were calculated based on the thus-measured masses of Ce. Then, effective amounts of CeO₂ were calculated based on the calculated masses of CeO₂ and the surface areas of the substrates.

Further, the particle diameters of the polishing agents in Table 1 were measured by the aforementioned method, with use of SALD-2200 produced by Shimadzu Corporation, as a laser diffraction particle size analyzer.

TABLE 1

| | | polishing step | | | | | | |
|---|---|---|---|---|---|---|---|---|
| | | | | | content of | | | |
| | | | | | dispersant | | particle diameter | |
| | | effective | CeO₂/ | dispersant/ | to 100 | | of polishing agent | |
| | lapping | amount of | polishing | polishing | parts by | | (μm) | |
| | step | CeO₂ | solution | solution | mass | | maximum | |
| | Ra (μm) | (μg/cm²) | (mass %) | (mass %) | of CeO₂ | dispersant | value | D50 |
| Ex 1 | 0.089 | 0.485 | 7.0 | 0.0180 | 0.25 | polycarboxylic | 3.5 | 1.1 |
| | | | | | | acid type | | |
| Ex 2 | 0.091 | 0.497 | 7.0 | 0.3500 | 5 | polycarboxylic | 3.5 | 1.0 |
| | | | | | | acid type | | |
| Ex 3 | 0.091 | 0.477 | 7.0 | 0.0700 | 1 | polycarboxylic | 3.5 | 0.9 |
| | | | | | | acid type | | |
| Ex 4 | 0.085 | 0.132 | 5.0 | 0.0125 | 0.25 | polycarboxylic | 3.5 | 1.2 |
| | | | | | | acid type | | |
| Ex 5 | 0.093 | 0.133 | 5.0 | 0.2500 | 5 | polycarboxylic | 3.5 | 0.8 |
| | | | | | | acid type | | |
| Ex 6 | 0.097 | 0.154 | 3.0 | 0.0075 | 0.25 | polycarboxylic | 3.5 | 1.0 |
| | | | | | | acid type | | |
| Ex 7 | 0.083 | 0.056 | 3.0 | 0.1500 | 5 | polycarboxylic | 3.5 | 1.0 |
| | | | | | | acid type | | |
| Ex 8 | 0.083 | 0.061 | 3.0 | 0.0300 | 1 | polycarboxylic | 3.5 | 0.8 |
| | | | | | | acid type | | |
| Ex 9 | 0.092 | 0.132 | 5.0 | 0.0125 | 0.25 | polysulfonic | 3.5 | 0.9 |
| | | | | | | acid type | | |
| Ex 10 | 0.090 | 0.203 | 5.0 | 0.2500 | 5 | polysulfonic | 3.5 | 1.1 |
| | | | | | | acid type | | |
| Ex 11 | 0.124 | 0.189 | 5.0 | 0.2500 | 5 | polycarboxylic | 3.5 | 1.2 |
| | | | | | | acid type | | |
| Ex 12 | 0.153 | 0.197 | 5.0 | 0.2500 | 5 | polycarboxylic | 3.5 | 0.7 |
| | | | | | | acid type | | |
| Ex 13 | 0.094 | 0.476 | 7.0 | 0.0070 | 0.1 | polycarboxylic | 3.5 | 0.9 |
| | | | | | | acid type | | |
| Ex 14 | 0.085 | 0.489 | 7.0 | 0.7000 | 10 | polycarboxylic | 3.5 | 1.1 |
| | | | | | | acid type | | |
| Ex 15 | 0.083 | 0.052 | 3.0 | 0.0030 | 0.1 | polycarboxylic | 3.5 | 0.9 |
| | | | | | | acid type | | |
| Ex 16 | 0.085 | 0.064 | 3.0 | 0.3000 | 10 | polycarboxylic | 3.5 | 1.1 |
| | | | | | | acid type | | |
| CEx 1 | 0.087 | 0.682 | 8.0 | 0.1600 | 2 | polycarboxylic | 3.5 | 0.9 |
| | | | | | | acid type | | |
| CEx 2 | 0.089 | 0.021 | 2.5 | 0.0500 | 2 | polycarboxylic | 3.5 | 1.0 |
| | | | | | | acid type | | |
| CEx 3 | 0.089 | 1.532 | 15.0 | 0.7500 | 5 | polycarboxylic | 3.5 | 1.0 |
| | | | | | | acid type | | |

### Examples 1 to 10, Example 13 to 16, and Comparative Examples 1 to 3

A disk processing step was performed by a well-known method, with use of alumino-silicate raw glass plates. Thereafter, a first lapping step and a second lapping step to be described later were performed.

The first lapping step was performed by applying a mechanical method using isolated abrasive grains by a flat grinding machine (produced by SpeedFam Co., Ltd). A polishing process was performed in such a manner that the overall surfaces of the glass substrates had a substantially uniform surface roughness (Ra=about 0.01 to 0.4 μm) with use of the isolated abrasive grains.

The second lapping step was performed by grinding the principal surfaces of the raw glass plates which have undergone the first lapping step, with use of a fixed abrasive grain polishing pad. Specifically, raw glass plates which have undergone the first lapping step were set in a lapping device, and the surfaces of the glass substrates were lapped with use of Trizact™ 2 μm (three-dimensional fixed polishing article having a surface pattern like a diamond tile, the size of the diamond tile: 2 μm). By performing the lapping, the surface roughnesses of the raw glass plates as shown by Ra in Table 1, specifically, the values described in the column of Ra in the lapping step shown in Table 1 were obtained. The raw glass plates having the surface roughnesses Ra as shown in Table 1 were subjected to a polishing step to be described later.

The surface roughnesses Ra were measured by using a contact type surface roughness measuring apparatus (produced by KLA-Tencol Co., Ltd.).

Thereafter, substantially the same rough polishing step as in a well-known method was performed, except that the polishing solutions as shown in Table 1 were used in the experiment.

Thereafter, a washing step was performed by a well-known method.

Specifically, the raw glass plates were immersed in a washing solution containing 1 mass % of hydrofluoric acid (HF) and 3 mass % of sulfuric acid for six minutes. In the immersion, 80 kHz ultrasonic vibration was applied to the washing solution. Thereafter, the raw glass plates were taken out. Then, the raw glass plates were immersed in a neutral washing solution for six minutes. In the immersion, 120 kHz ultrasonic vibration was applied to the neutral washing solution. Lastly, the raw glass plates were taken out, rinsed with deionized water, and subjected to IPA drying.

Thereafter, a chemically reinforcing step, a fine polishing step (secondary polishing step), and a final washing step were performed by a well-known method.

As a chemically reinforcing step, specifically, a mixed melt obtained by melting potassium nitride and sodium nitride was prepared. The mixed melt was obtained by setting the mixing ratio of potassium nitride and sodium nitride to 1:1 in mass ratio. The mixed melt was heated to 400° C., and the raw glass plates which have undergone the washing were immersed in the heated mixed melt for sixty minutes.

### Example 11 and Example 12

Example 11 and Example 12 were obtained substantially in the same manner as the aforementioned examples, except that Trizact™ 4 μm (diamond tile) was used in place of Trizact™ 2 μm (diamond tile). The conditions in Example 11 and Example 12 were substantially the same as those in the aforementioned examples, as shown in Table 1.

The glass substrates for information recording media obtained by the respective manufacturing methods were evaluated as follows.

(Surface Roughness Ra)

Firstly, the surface roughnesses Ra of the thus-obtained glass substrates for information recording media were measured with use of an atomic force microscope (AFM) (AFM produced by Veeco Instruments Inc.: Dimension V). The measurement was performed with use of two-hundred fifty-six scanning lines (10×10 μm).

(Crack Test)

Firstly, magnetic disks were manufactured by forming magnetic films on the surfaces of the thus-obtained glass substrates for information recording media by a well-known method. Then, hard disk drive devices (HDDs) incorporated with the magnetic disks were manufactured.

Then, the HDDs were dropped so that an impact of 1,000 G was exerted on the HDDs. At the time of dropping, presence or absence of cracks in the magnetic disks incorporated in the HDDs were visually checked. It should be noted that 1G corresponds to about 9.80665 m/s².

The drop test was carried out ten times. In the case where the number of times at which the magnetic disks were cracked was zero, the magnetic disks were evaluated to be excellent (⊚). In the case where the number of times at which the magnetic disks were cracked was one time or two times, the magnetic disks were evaluated to be good (◯). In the case where the number of times at which the magnetic disks were cracked was three to five times, the magnetic disks were evaluated to be fair (Δ), and in the case where the number of times at which the magnetic disks were cracked was more than five times, the magnetic disks were evaluated to be poor (X).

The results are as shown in Table 2.

TABLE 2

| | Ra (nm) | Crack Test |
|---|---|---|
| Example 1 | 0.39 | ⊚ |
| Example 2 | 0.37 | ⊚ |
| Example 3 | 0.34 | ⊚ |
| Example 4 | 0.32 | ⊚ |
| Example 5 | 0.31 | ⊚ |
| Example 6 | 0.34 | ⊚ |
| Example 7 | 0.30 | ⊚ |
| Example 8 | 0.25 | ⊚ |
| Example 9 | 0.39 | Δ |
| Example 10 | 0.37 | Δ |
| Example 11 | 0.39 | Δ |
| Example 12 | 0.37 | Δ |
| Example 13 | 0.52 | ◯ |
| Example 14 | 0.48 | ◯ |
| Example 15 | 0.41 | ◯ |
| Example 16 | 0.42 | ◯ |
| Comparative Example 1 | 0.51 | X |
| Comparative Example 2 | 0.43 | X |
| Comparative Example 3 | 0.55 | X |

As is obvious from Table 2, in the case (Examples 1 to 16) where the rough polishing step is a step of performing polishing in such a manner that the effective amount of CeO₂ per unit area of the surface of the raw glass plate to be used in the polishing is in the range of from 0.05 to 0.5 μg/cm², as compared with a case (Comparative Example 2) where the rough polishing step is a step of performing polishing in such a manner that the effective amount of CeO₂ to be used in the polishing is smaller than 0.05 μg/cm², and a case (Comparative Example 1 and Comparative Example 3) where the rough polishing step is a step of performing polishing in such a manner that the effective amount of CeO₂ to be used in the polishing exceeds 0.5 μg/cm², it is clear that Ra is small and cracks in the crack test are suppressed. This shows that the manufacturing method for manufacturing glass substrates for information recording media as exemplified in Examples 1 through 16 is advantageous in manufacturing a glass substrate having enhanced smoothness and enhanced impact resistance.

The specification discloses the aforementioned features. The following is a summary of the primary features of the embodiment.

An aspect of the invention is directed to a method for manufacturing a glass substrate for an information recording medium including a polishing step of polishing a surface of a raw glass plate, with use of a polishing solution containing a polishing agent and water; and a chemically reinforcing step of reinforcing the surface of the raw glass plate which has undergone the polishing step, with use of a chemically reinforcing treatment solution, wherein the polishing step is a step of using, as the polishing agent, a polishing agent containing CeO₂, and of performing polishing in such a manner that an effective amount of CeO₂ per unit area of the surface of the raw glass plate to be used in the polishing is in the range of from 0.05 to 0.5 μg/cm².

In the above configuration, it is possible to provide a method for manufacturing a glass substrate for an information recording medium having enhanced smoothness and enhanced impact resistance.

The above finding is based on the following observation.

Conceivably, in the polishing step to be performed prior to the chemically reinforcing step, it is possible to increase the polishing speed, and to enhance the smoothness of the raw glass plate which has undergone the polishing step by using a polishing agent containing CeO₂, as the polishing agent. The above finding is based on the following reason. Firstly, in the case where a raw glass plate is contacted with CeO₂ in a state that a pressure is applied to the surface of the raw glass plate in polishing, Si—O bond, which is a main composition in the surface of the raw glass plate is replaced by Ce—O bond. Ce—O bond is easily broken, but bonding between Si and O is less likely to occur. In view of the above, it is conceived that use of a polishing agent containing CeO₂ is advantageous in increasing the polishing speed and in sufficiently enhancing the smoothness of the raw glass plate which has undergone the polishing step.

Further, in the polishing step to be performed prior to the chemically reinforcing step, a polishing agent containing CeO₂ is used as the polishing agent, and polishing is performed in such a manner that the effective amount of CeO₂ per unit area of the surface of the raw glass plate to be used in the polishing is in the range of from 0.05 to 0.5 μg/cm². The above configuration is advantageous in sufficiently enhancing the smoothness and the cleanliness of the raw glass plate which has undergone the polishing step, while maintaining the polishing speed. It is conceived that the above advantage is obtained by setting an effective pressure at the time of polishing to an appropriate pressure.

Further, it is conceived that uniform chemical reinforcement is secured by applying a chemically reinforcing step to the raw glass plate having such enhanced smoothness and cleanliness.

As described above, it is possible to manufacture a glass substrate for an information recording medium having enhanced smoothness and enhanced impact resistance.

Further, in the method for manufacturing a glass substrate for an information recording medium, preferably, a content of the polishing agent in the polishing solution may be in the range of from 3 to 7 mass % with respect to the water, the polishing solution may contain a dispersant having a negative electric charge, and a content of the dispersant may be in the range of from 0.25 to 5 parts by mass with respect to 100 parts by mass of CeO₂.

In the above configuration, it is possible to provide a method for manufacturing a glass substrate for an information recording medium having enhanced smoothness and enhanced impact resistance.

The above finding is based on the following observation.

Conceivably, a dispersant having a negative electric charge is capable of suppressing agglomeration of the polishing agent, because the polishing agent dispersed in water and containing CeO₂ has a positive electric charge. Containing a dispersant having a negative electric charge in the polishing solution having a feature that the concentration of the polishing agent is lowered to such a level that the content of the polishing agent in the polishing solution is in the range of from 3 to 7 mass % with respect to water is advantageous in sufficiently enhancing the dispersibility of the polishing agent containing CeO₂. In other words, it is possible to prepare a polishing solution, in which the particle diameter distribution range of the polishing agent is narrow.

Conceivably, polishing with use of a polishing solution in which a polishing agent is appropriately dispersed as described above provides the following advantages. Namely, in view of a point that the particle diameter distribution range is narrow, it is less likely that the polishing agent may include polishing particles of an excessively small diameter or polishing particles of an excessively large diameter. Accordingly, it is possible to set an effective pressure at the time of polishing to an intended pressure. Thus, the above configuration is advantageous in enhancing the smoothness and the cleanliness of a raw glass plate which has undergone the polishing step, while maintaining the polishing speed. Further, it is conceived that the impact resistance can be enhanced by applying the chemically reinforcing step.

As described above, it is possible to manufacture a glass substrate for an information recording medium having enhanced smoothness and enhanced impact resistance.

Further, in the method for manufacturing a glass substrate for an information recording medium, preferably, the polishing step may be at least one selected from the group consisting of polishing a principal surface of the raw glass plate, polishing an inner circumferential end surface of the raw glass plate, and polishing an outer circumferential end surface of the raw glass plate.

Polishing with use of the polishing solution in one of the aforementioned steps is advantageous in enhancing the smoothness and the cleanliness of the raw glass plate which has undergone the polishing. Specifically, applying a chemically reinforcing step is advantageous in enhancing the impact resistance, as well as enhancing the smoothness. It is preferable to perform polishing with use of the polishing solution in all the steps.

Further, in the method for manufacturing a glass substrate for an information recording medium, preferably, the dispersant may be a material of at least one kind selected from the group consisting of polycarboxylic acids and derivatives thereof.

In the above configuration, it is possible to manufacture a glass substrate for an information recording medium having enhanced smoothness and enhanced impact resistance.

The above finding is based on the following observation.

Conceivably, use of polycarboxylic acids or derivatives thereof as the dispersant is advantageous in enhancing the dispersibility of the polishing agent by the dispersant. Specifically, it is conceived that polycarboxylic acids or derivatives thereof are dissolved in a polishing solution, and generate polymers having COO⁻ groups in the molecules thereof. It is conceived that the polymers are effective in enhancing the dispersibility of the polishing agent by the dispersant.

Further, in the method for manufacturing a glass substrate for an information recording medium, preferably, the polishing agent may have a maximum value in a particle diameter distribution measured by a laser diffraction/scattering method of 3.5 μm or smaller, and may have D50 in the particle size distribution measured by the laser diffraction/scattering method in the range of from 0.5 to 1.5 D50 representing a particle diameter corresponding to 50 vol % of an accumulation curve.

In the above configuration, it is possible to manufacture a glass substrate for an information recording medium having enhanced impact resistance, and it is possible to manufacture an information recording medium having enhanced smoothness, while securing a high polishing speed. It is conceived that the above advantage is obtained because use of a polishing agent satisfying the aforementioned particle diameter range enables to suppress formation of scratches by polishing, while securing a high polishing speed.

Further, in the method for manufacturing a glass substrate for an information recording medium, preferably, a content of CeO₂ may be 60 mass % or more with respect to a total mass of solid content of the polishing solution.

In the above configuration, it is possible to manufacture a glass substrate for an information recording medium having enhanced impact resistance, and it is possible to manufacture a glass substrate for an information recording medium having enhanced smoothness. Further, the above configuration is advantageous in increasing the polishing speed. It is conceived that these advantages are obtained because the content of CeO₂ capable of enhancing the polishing performance is sufficiently large with respect to the total mass of solid content of the polishing solution.

Further, the method for manufacturing a glass substrate for an information recording medium may preferably further include a step of grinding the raw glass plate prior to the polishing step, wherein an arithmetic average roughness Ra of a surface of the raw glass plate which has undergone the grinding is 0.1 μm or smaller.

In the above configuration, it is possible to provide a method for manufacturing a glass substrate for an information recording medium having enhanced smoothness and enhanced impact resistance.

The above finding is based on the following observation.

Conceivably, it is possible to enhance the smoothness and the impact resistance of a finally-obtained glass substrate by enhancing, to some extent, the smoothness of a raw glass plate which has undergone the grinding step to be performed prior to the polishing step, in addition to the polishing step to be performed prior to the chemically reinforcing step, wherein the polishing step is a step capable of enhancing the smoothness and the impact resistance as described above. Specifically, it is preferable to set the arithmetic average roughness Ra of the surface of the raw glass plate which is subjected to the polishing step to 0.1 μm or smaller.

### INDUSTRIAL APPLICABILITY

The invention provides a method for manufacturing a glass substrate for an information recording medium having enhanced smoothness and enhanced impact resistance.

1. A method for manufacturing a glass substrate for an information recording medium, comprising:
a polishing step of polishing a surface of a raw glass plate, with use of a polishing solution containing a polishing agent and water; and
a chemically reinforcing step of reinforcing the surface of the raw glass plate which has undergone the polishing step, with use of a chemically reinforcing treatment solution, wherein
the polishing step is a step of using, as the polishing agent, a polishing agent containing CeO2, and of performing polishing in such a manner that an effective amount of CeO2 per unit area of the surface of the raw glass plate to be used in the polishing is in the range of from 0.05 to 0.5 μg/cm2.

2. The method for manufacturing a glass substrate for an information recording medium according to claim 1, wherein
a content of the polishing agent in the polishing solution is in the range of from 3 to 7 mass % with respect to the water,
the polishing solution contains a dispersant having a negative electric charge, and a content of the dispersant is in the range of from 0.25 to 5 parts by mass with respect to 100 parts by mass of CeO2.

3. The method for manufacturing a glass substrate for an information recording medium according to claim 1 or claim 2, wherein the polishing step is at least one selected from the group consisting of polishing a principal surface of the raw glass plate, polishing an inner circumferential end surface of the raw glass plate, and polishing an outer circumferential end surface of the raw glass plate.

4. The method for manufacturing a glass substrate for an information recording medium according to claim 1, wherein
the dispersant is a material of at least one kind selected from the group consisting of polycarboxylic acids and derivatives thereof.

5. The method for manufacturing a glass substrate for an information recording medium according to claim 1, wherein
the polishing agent has a maximum value in a particle diameter distribution measured by a laser diffraction/scattering method of 3.5 μm or smaller, and has D50 in the particle size distribution measured by the laser diffraction/scattering method in the range of from 0.5 to 1.5 μm, D50 representing a particle diameter corresponding to 50 vol % of an accumulation curve.

6. The method for manufacturing a glass substrate for an information recording medium according to claim 1, wherein
a content of CeO2 is 60 mass % or more with respect to a total mass of solid content of the polishing solution.

7. The method for manufacturing a glass substrate for an information recording medium according to claim 1, further comprising:
a step of grinding the raw glass plate prior to the polishing step, wherein an arithmetic average roughness Ra of a surface of the raw glass plate which has undergone the grinding is 0.1 μm or smaller.
